(19) United States
(12) Patent Application Publication
(10) Pub. No.: US 2005/0144120 A1
(43) Pub. Date: Jun. 30, 2005

(54) Method for funding non-profit organizations and not-for-profit funds

(76) Inventor: K. Bryce Flake, Alpine, UT (US)

Correspondence Address: Vaughn W. North;THORPE NORTH & WESTERN, LLP, P.O. Box 1219, Sandy, UT, 84091-1219, US

(21) Appl. No.: 10/742,152

(22) Filed: Dec. 18, 2003

(51) Int. Cl. G06F 17/60

(52) U.S. Cl. 705/39

(57) ABSTRACT

The invention provides a system and method for funding a non-profit organization. The method can include the operation of identifying persons having an interest in a non-profit organization. A further operation can be identifying at least one product and/or service typically acquired by those persons. Another operation is initiating a sale of the at least one product and/or service made to the persons having an interest in the non-profit organization. The earnings from the sale of the at least one product and/or service are organized and distributed to an escrow account. A further operation can be organizing distribution of the earnings from the escrow account according to instructions from the non-profit organization.

### FIELD OF THE INVENTION

The present invention relates generally to the funding of non-profit organizations.

### BACKGROUND

Non-profit organizations fulfill an important niche in society, allowing charitable groups to receive the legal protection of a business while minimizing costs by obtaining a tax free status. In order to be classified as non-profit, the organization must carefully control the amount of income earned each year. If a non-profit earns more money than is needed to run the organization it may affect their status as non-profit. This can be especially difficult for small non-profit organizations that don't have the time or resources to carefully track their earnings.

Such limitations frequently require non-profit organizations to invent unique and often inefficient methods for raising capital. Every year scout troops, athletic teams, schools, and other organizations send their members out to sell merchandise to friends and family in order to raise sufficient money to run the organization. The organization usually only receives a small percentage from the total merchandise sold. Thus, the organizations regularly have to burden friends, neighbors and families to collectively spend significant time and/or a much greater sum than the overall budget requirements of the organization.

Not only can the non-profit organization fund raising activities be inefficient, they can also be oppressive. People can be approached dozens of times each year by neighbor kids, co-workers, relatives, and complete strangers selling merchandise. The merchandise is rarely needed by those who purchase it. The large number of non-profit organizations selling unwanted merchandise can create a strain on people's budgets, causing them to become jaded to even the best causes.

### SUMMARY OF THE INVENTION

The invention provides a system and method for funding a non-profit organizations and not-for profit funds. The method can include the operation of identifying persons having an interest in a non-profit organization. A further operation can be identifying at least one product or service typically acquired by those persons. Another operation is initiating a sale of the at least one product or service made to the persons having an interest in the non-profit organization. The earnings from the sale of the at least one product or service are organized and distributed to an escrow account. A further operation can be organizing distribution of the earnings from the escrow account according to instructions from the non-profit organization or not-for-profit fund.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a graphic representation of the present invention; and

FIG. 2 is a flow chart illustrating one embodiment of the present invention.

FIG. 3 is a graphic representation of one embodiment of a computer-implemented system for funding a non-profit organization.

FIG. 4 is an additional embodiment of the computer-implemented system of FIG. 3.

FIG. 5 is an additional embodiment of the graphic representation of the present invention of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

By definition, the term non-profit organization, as used in this application, may also encompass not-for-profit-activities, both inside non-profit organizations and not-for profit activities external to the non-profit organizations.

Non-profit organizations have attempted to solve the problems associated with funding using a variety of methods. One method that has been attempted in the past was to use network marketing. Network marketing involves a salesperson selling a product and/or service to customers and encouraging the customers to also sell the product and/or service to others. When the customers sell the product or service, they get a percentage of the earnings, with a percentage also going to the salesperson that sold them the product. Each time a customer begins selling, a new level is created in the marketing plan. That customer can find customers below him or her to begin selling the product and/or service, creating another level. The more levels that are created below the salesperson, the more potential there is for earnings.

Such a marketing plan can be implemented successfully and create a residual based income for a non-profit organization. The organization members can work to find people to help them sell products and/or services to fund the organization. Those people can find other people to help sell products and services, and so on. However, a lack of control over the earnings from network marketing makes this type of marketing risky for many small non-profit organizations. Without adequate supervision and control over the sales, earnings have the potential to quickly become greater than the needs of the organization. The surplus earnings can threaten the non-profit status of the organization. What is needed is a method for funding non-profit organizations without further straining the budgets of members' friends and relatives, while also keeping the organization's non-profit status safe.

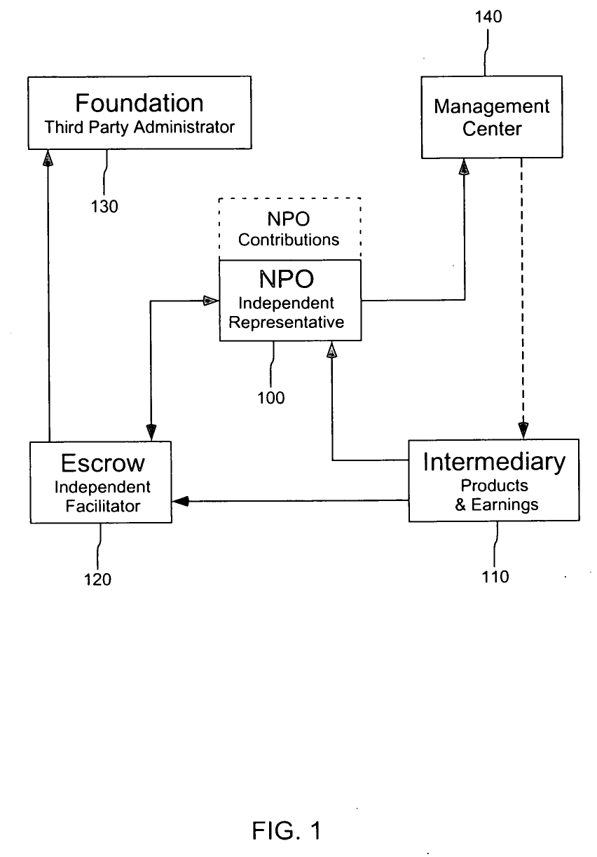

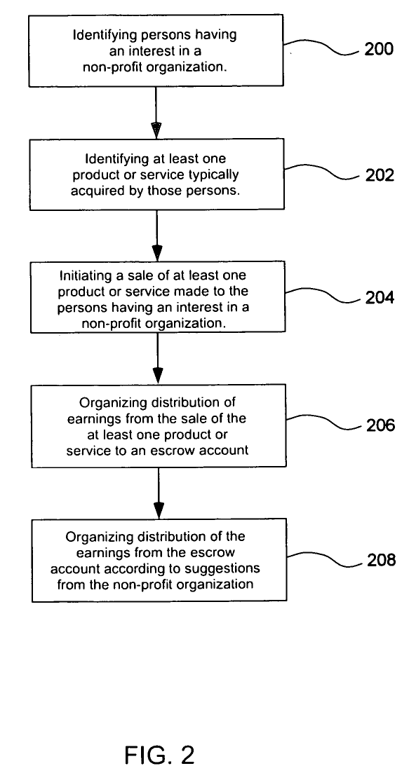

In order to overcome the problems described and to provide a method for funding non-profit organizations without jeopardizing the non-profit status of the organization or straining the budgets of members' friends and relatives, the present invention provides a method for funding a non-profit organization, as illustrated in FIG. 2. Throughout the discussion below, reference will also be made to groups and organizations whose interactions are shown in FIG. 1.

A brief overview of the organizations in FIG. 1 is necessary to understand the method for funding non-profit organizations. A management center 140 uses network marketing to recruit and train members and other persons sympathetic to non-profit organizations 100 to become independent representatives of an intermediary 110. The intermediary provides products and services for the non-profit organization to sell. A percentage of the profits from the sale of goods and services are then put in a general escrow account 120 that operates as an independent facilitator. The independent facilitator then distributes the money in each non-profit organization's escrow account according to the instructions provided by the non-profit organization. Any excess earnings not needed by the non-profit organization are given by the escrow account to a foundation 130 that is run by a board. The foundation acts in the capacity of a third party administrator. The foundation donates the excess funds to a charitable cause according to suggestions provided by the non-profit organization.

The method for funding non-profit organizations includes the operation of identifying persons having an interest in a non-profit organization in block 200. The management center 140, using network marketing as discussed below, will provide a system by which salespersons will be able to find persons having an interest in a non-profit organization. Persons having an interest in a non-profit organization 100 may include the neighbors, friends, and relatives of members of the organization. It may also include those simply having an interest in the non-profit organization or its charter. For example, a Boy Scout group may be a non-profit organization. Families and friends of a Boy Scout will likely have an interest in funding the Boy Scout group based on this relationship. Persons who are strangers with the scout may also be interested in helping the boy scouts due to the organization's charter.

A further operation is the step of identifying at least one product or service typically acquired by those persons having an interest in the non-profit organization in block 202. The management center 140 will identify at least one product or service that is typically acquired by those persons having an interest in the non-profit organization. The product and/or service typically acquired may be selected specifically for a certain organization, or it may be a general product and/or service that is frequently or periodically purchased by the general public. For example, the product may be magazines that the public usually purchases each year. Renewing a subscription to Reader's Digest® through the local scout troop may not cost any more than renewing the magazine through normal channels.

Another example of relevant products and/or services may be the purchasing of utilities through an intermediary group 110. The intermediary may be able to purchase telephone, electric, gas, sewer, water, garbage, and other utilities in a bulk amount at a discounted rate, and then pass the savings on to others. Nearly every homeowner purchases utilities such as gas, electric, telephone, water, sewer, and garbage each month. Members of the non-profit organization 100, their friends, neighbors, and families may purchase their utilities through the intermediary rather than paying another local utility provider. The switch to purchasing utilities through the intermediary may cost little or nothing. The profit derived from the utilities used each month can be used to fund the non-profit organization without burdening the non-profit supporters, since the supporters were already purchasing utilities. Similarly, the intermediary may sell food, gasoline, financial products such as insurance, mortgage securities, private and commercial loans, investment placements, and other products and/or services that are frequently purchased by consumers.

An additional operation is initiating the sale of at least one product or service made to the persons having an interest in a non-profit organization in block 204. The sales generated through the members of the non-profit organization 100 can be initiated through the intermediary 110 or through the management center 140. The management center may be part of the intermediary, or it may be an independent group that initiates and coordinates sales activities by the non-profit organization. The management center can train sales people to recruit non-profit organizations that are interested in fund raising. The management center can also be used to train members and supporters of the non-profit organization to sell products and/or services for fund raising.

Once the product or service is sold by a member or supporter of the non-profit organization, the intermediary can receive payment and ship the product and/or perform the service. The profit from the sale of the good and/or service can then be sent to the non-profit organization's escrow account. Thus, the sales people working under the non-profit organization may not have to deal with financial or shipping issues involved in sales. The processing of the sale may also be performed by the management center 140. The management center will be discussed in more detail below.

Another operation involves organizing distribution of earnings from the sale of the at least one product or service to an escrow account as in block 206. In one embodiment, the management center can train sales people to recruit non-profit organizations. A sales person can recruit a Boy Scout troop. The members and supporters of the Boy Scout troop may sign up many of their friends and relatives to purchase utilities through the intermediary 110. The intermediary or management center 140 can bill the customers that now purchase utilities through the intermediary, collect the money, and place the profits from the sale of utilities to the customers signed up by the members and supporters of the Boy Scout troop into an escrow account 120 created for the Boy Scout troop. The funds placed in the escrow account can then be controlled by the escrow, acting as an independent facilitator. The Boy Scouts can have minimal involvement once the initial sale is made. Nevertheless, funds continue to flow to the Boy Scout troop or other charitable organization with each successive purchase.

A further operation is organizing the distribution of the earnings in the escrow according to instructions from the non-profit organization as in block 208. The management center 140 can instruct the non-profit organization 100 to give the escrow 120 instructions on how the money in the non-profit organization's account should be distributed. The escrow, acting as an independent facilitator, will follow all escrow instructions given to it by the non-profit organization. The non-profit organization can inform the escrow of its budget needs for the year, any surplus needs, and what to do with any excess. The escrow can then supply the non-profit organization's budgetary requirements along with any surplus needs the organization may have. The amount that can be supplied from the escrow account is only limited by the budgetary and surplus needs of the non-profit organization, and the amount of money that is in the escrow account.

For example, a baseball team may be a non-profit organization with budget needs of $3,000 for the year. The team may need to make some improvements to their practice facilities costing $5,000. The team may also need an extra $8,000 if they qualify to play in the regional finals in the playoffs. The management center can have the team instruct the escrow 120, acting as an independent facilitator, of their budgetary needs of $3,000 and also of their possible surplus needs of $5,000 for facility repairs and $8,000 in traveling expenses for the year. Throughout the year, the team members can sell products and/or services to their families, friends, neighbors, relatives, and the public that they typically acquire, such as utilities, magazines, food, or gas. These products and/or services may be supplied through the intermediary 110. The earnings from the sales can then flow from the intermediary into the escrow account created for the baseball team each month. The escrow can ensure that the first $3,000 in earnings from the team's sales will go to the baseball team to fund their non-profit organization. An additional $13,000 can be held by the escrow to pay for improvements, and, if needed, money to fund the trip to the regional finals.

Any excess earnings taken in by the fundraising activities of the baseball team can be sent by the escrow to a foundation 130. The foundation can act in the capacity of a third party administrator that acts independent of the non-profit organization 100, the escrow 120, and the intermediary 110. The foundation will be instructed by the management center 140 to follow the suggestions of the non-profit organization and will administer the contributions accordingly. In the above example, if the baseball team earned $17,000 through fund raising activities, but didn't make the regional finals, the team would have $9,000 of excess funding after their $3,000 budget and $5,000 in facility repairs. The team can suggest to the foundation, through the management center, which charitable organizations they would like their excess funding to go to. The escrow will give any excess funds, in this case the $9,000.00, to the foundation. The foundation will then administer the contributions according to the team's suggestions. The team, working through the management center, may suggest to the foundation that they want any excess funding to go to the city's little league charitable fund, where it can help other teams that didn't have a surplus in fund raising.

Economies of scale can be used to increase the percentage of profits made from the sale of products and/or services. In order for an intermediary 110 to distribute and sell products or services at a discount, allowing the non-profit organization 100 to make a profit, a large number of sales must be made. One way to make a large number of sales is through the use of network marketing. Network marketing can be used to find non-profit organizations and recruit their members to sell products and/or services. Network marketing can also be used by the non-profit organizations to maximize their income potential, helping to ensure that the organization will meet their budgetary needs.

In one embodiment, a management center 140 can recruit salespeople to locate non-profit organizations 100 that are interested in fundraising. These salespeople can recruit other salespeople to work for, and/or in other words, under them. The salespeople can find non-profit organizations interested in fundraising and sign each non-profit organization up as an independent representative of the intermediary 110. The salespeople can keep a percentage of the profits from the sales. They can earn a smaller percentage from the sales made by the salespeople under them.

Similarly, the non-profit organizations 100 recruited by the salespeople, as independent representatives of the intermediary 110, can have their members recruit other members, friends, neighbors, and the public to help them sell the intermediary's product and/or service. The newly recruited members, friends, neighbors, and public can then recruit people below them to help sell the products and/or services. Each salesperson may keep a percentage of the profits generated from the sale of products and/or services by the people they recruit to be below them.

Thus, a small number of salespeople can quickly generate a large sales force to recruit non-profit organizations to sell products and/or services. Likewise, non-profit organizations can quickly recruit a large number of people to help them sell the goods and/or services, with a percentage of the profits going to fund the non-profit organization. By using network marketing, economies of scale can be used to sell a large number of products and/or services at competitive prices while maintaining enough profit to pay the salespeople and fund the non-profit organization.

The management center 140 can also be used as a training and resource center. As discussed above, the management center can work with the intermediary 110 to supply training to the salespeople, both those seeking non-profit organizations and those selling products and/or services under the non-profit organization. The management center can provide pamphlets and literature which can be used by the salespeople to sell the products and services. The management center can interact between the intermediary 110, the non-profit organization 100, the escrow 120, and the foundation 130.

The management center may have the non-profit organizations sign agreements enabling each of the members of the non-profit organization to alter the beneficiary of the profits received from the member's sale of goods and/or services after a certain amount of time. Thus, a member of a little league team that sold goods and/or services to support the little league team, can later have the profits from any continued sales redirected from the excess earnings of the little league team to his and/or her high school team. The high school team will also have to be a participating non-profit organization to receive the funds.

In some situations, the non-profit organization 100 may not be able to become an independent representative of the intermediary 110. In such situations, the non-profit organization's supporters, booster club members, board members, and/or the like can create an LLC and/or another non-profit entity that is structured under the corpus of the trust and/or business. The newly created LLC and/or non-profit entity can then become the independent representative of the intermediary, allowing the non-profit organization to become an independent representative of the intermediary and sell the products and/or services provided by the intermediary.

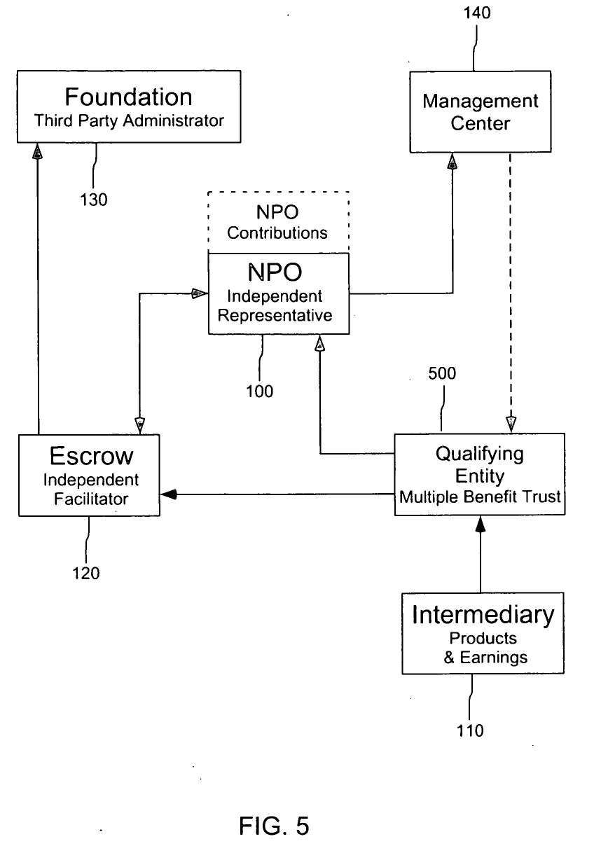

In another embodiment, a non-profit organization 100 may be sponsored by some other form of qualifying entity such as a position in a multiple benefit trust 500, as shown in FIG. 5. The multiple benefit trust is comprised of multiple units, and/or positions. The multiple benefit trust may have thousands of these positions. Each position is known as an agent sponsor position. Each non-profit organization can be represented by an agent sponsor position in the multiple benefit trust. In this embodiment, the agent sponsor position in the multiple benefit trust becomes the independent representative of the intermediary. The non-profit organization can be sponsored by an agent sponsor position for each product and/or service sold. Thus, if the non-profit organization sold magazines and financial products, the non-profit organization would be sponsored by two separate agent sponsor positions, with each agent sponsor position representing one of the products sold by the non-profit organization. If a non-profit organization decides to be sponsored by two and/or more agent sponsor positions, each of those positions will be connected one to another, thereby allowing for proper accounting and the rating of the agent sponsor positions involved, as discussed below. The profits derived from the sale of goods can go from the multiple benefit trust as a qualified entity into the escrow account.

Each of the agent sponsor positions can be rated according to various qualifications. The rating of the agent sponsor position can be based upon qualifications comprising the type of non-profit organization, its budget needs and surplus wants, capital volume, years of operation, membership numbers, territorial circumstances, available resources, etc. The rating selections may also be aided by an actuarial forum as well.

The agent sponsor positions can be organized into larger groups called teams. A portion of the excess money sent from the non-profit organization 100 to the foundation 130 can then be redistributed according to the rating of the agent sponsor position. For example, a team may consist of 82 agent sponsor positions. The strongest agent sponsor positions will be given an A rating, with B, C, and D ratings for the weaker positions. Each team may be composed of substantially fifty D rated agent sponsor positions, twenty C rated, ten B rated, and two A rated positions. Each agent sponsor position may receive a different rating at any time, allowing for proper growth adjustments and the strengthening of each team.

The multiple benefit trust can take a portion of the excess funds each non-profit organization donates to the foundation and redistribute the excess funds according to the budget needs and surplus needs of each agent sponsor position. Once a participating non-profit organization member has been matched and/or assigned with an agent sponsor position within a team, it will then be eligible to receive gifts and/or grants from the foundation donated by other agent sponsor position members of the team. Lower rated agent sponsor positions can receive a larger portion of available gifts and grants to enable the non-profit organization to excel within the team. When all of the agent sponsor positions within in a team are given an A rating, excess funds from the A-rated team can be distributed to other teams within the multiple benefit trust.

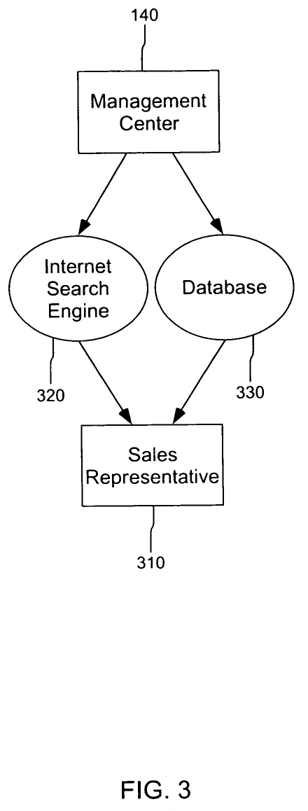

As a further embodiment of the present invention, a computer-implemented system for funding a non-profit organization can be incorporated, for example, to increase efficiency and effectiveness. The management center 140 may use a computer as a resource to help salespersons locate and contact non-profit organizations. Several uses of the computer may be implemented to increase the efficiency of contacting non-profit organizations. As illustrated in FIG. 3, the management center 140 may encourage sales representatives 310 to use an Internet search engine 320 to locate and contact non-profit organizations. Also, the management center may purchase a database 330 of non-profit organizations that can be viewed on a computer. Using the computer, the management center can ensure that the salespersons have current information to increase their effectiveness.

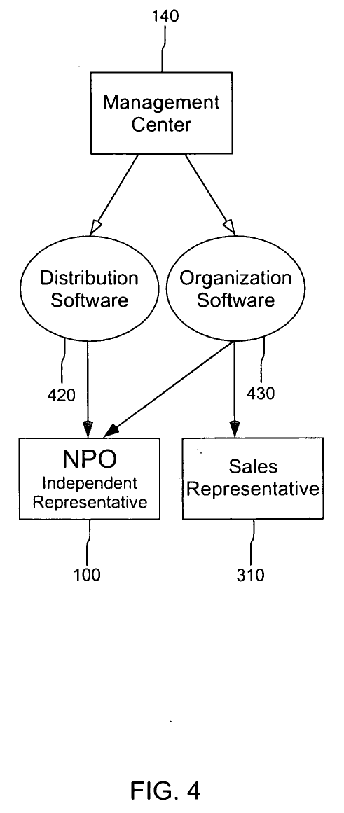

A proprietary computer program can also be implemented, in one embodiment, to help in organizing the distribution of earnings from the sale of at least one product and/or service to an escrow account, as shown in FIG. 4. The management center 140 can implement the organization software 430 to keep track of each salesperson 130, each non-profit organization 100, and the non-profit organization's members and supporters (not shown). The organization software can access a database (not shown) containing information that can be used to track such things as who made a sale, any commission that is owed to a sales representative before the profit is placed in an escrow account, the non-profit organization that a member and/or supporter is connected to, the profits due to each non-profit organization, and the like. This information can be made available on the Internet so that each salesperson can know of their earnings and each non-profit organization can easily find how much money may be available in their escrow account.

A proprietary computer program can be used, in another embodiment, as a means for organizing distribution of the earnings from the escrow account according to instructions from the non-profit organization. The distribution software 420 can be used similar to an online banking Internet site, wherein the management center 140 can enable a non-profit organization 100 to view the funds in the organization's escrow account, and change the allocation of money earned through fundraising if it becomes necessary and/or desirable. The money can be allocated, as mentioned above, in a budget, surplus, and extra funds. If the baseball team, in the example discussed above, found that the maintenance on their ballpark was going to cost $6500 instead of $5000 as they had planned on, the person in charge of fundraising for the team can log on to the internet and sign in to the team's escrow account website. The person in charge of fundraising can then alter the allotment of funds. If the team had raised $17,000, as discussed previously, $1500 can be moved from the extra fund to the surplus fund, allowing the team to easily allocate their fundraising according to their needs. The non-profit organization can also use the website to instruct the escrow how to allocate any extra funds. If the organization decides that any extra funds should be allocated differently, they can change the extra fund allocation instructions on the website provided by the management center and/or intermediary.

In another embodiment, smart cards may be used to allocate the budget and surplus funds. The smart card technology can allow the payment of earnings from the provider of the goods and/or services to the independent representative. The independent representative may be the non-profit organization and/or the agent sponsor position. The smart card account may dedicate the pre-determined budget and surplus amounts needed by the non-profit organization and distribute, credit, and/or contribute them directly to the non-profit organization's smart card account. The smart card technology may fulfill the function of the escrow, wherein all predetermined protocols, budgets and instructions can be stored in the smart card.

In a further embodiment, large membership organizations, both for-profit and non-profit, can purchase the products and/or services offered by the intermediaries and place the earnings into an account for a specific purpose. Large membership organizations can include churches, adult organizations like the Kiwanis clubs, Bikers Against Child Abuse, Mothers Against Drunk Driving, state parent teacher associations, commercial business', foundations and national collations and associations to organize not-for profit funds. For example, a small business can use a specific purpose fund to sponsor members of its management team to attend training seminars. A specific purpose fund can provide for the legal expense for the National Coalition for the Protection of Family and Children to fight companies selling pornographic material to minors on the internet. A church may create a not-for-profit fund from the earnings of the residual income provided from the purchases of goods and/or services by its membership to give aid to third world orphanages or other worthy causes.

The present invention has the advantage that it provides non-profit organizations 100 and their members with a method for funding their organization without burdening their neighbors and/or risking the organization's non-profit status. The management center 140 can supply a system that can provide for all the funding needs of a non-profit organization, as previously discussed in the example of the baseball team. The team doesn't need to spend excess time and/or money to manage the fund raising activities. The team's funds are managed by an escrow 120, acting as an independent facilitator. Any excess funds raised by the team are automatically sent by the escrow to the foundation 130, where the money is donated to the charitable cause suggested by the team. The team's friends, neighbors, and relatives are able to help the team by purchasing a product and/or service they already typically acquire, such as magazines and/or utility products like telephone, gas and/or electric service.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for funding non-profit organizations, comprising the steps of:
identifying persons having an interest in a non-profit organization;
identifying at least one product and/or service typically acquired by those persons;
initiating a sale of the at least one product and/or service made to the persons having an interest in the non-profit organization;
organizing distribution of earnings from the sale of the at least one product and/or service to an escrow account; and
organizing the distribution of earnings from the escrow account according to suggestions from the non-profit organization.

2. A method as in claim 1, further comprising the step of funding a budgetary requirement of the non-profit organization from the earnings that are placed in the escrow account.

3. A method as in claim 1, wherein the step of organizing distribution of the earnings from the escrow account includes the more specific step of directing distribution of the non-profit organization's earnings from the escrow account according to instructions to an escrow account manager including the non-profit organization's budgetary needs and surplus budget needs.

4. A method as in claim 3, further comprising the step of providing for donation of any excess earnings in the escrow account, available after the non-profit organization's budgetary needs and surplus budget needs have been met, to a foundation.

5. A method as in claim 4, further comprising the step of enabling the non-profit organization to suggest to the foundation to donate excess funds to one and/or more charitable causes.

6. A method as in claim 1, wherein the step of identifying persons having an interest in a non-profit organization includes the more specific step of using network marketing to identify persons having an interest in a non-profit organization.

7. A method as in claim 6, wherein the step of using network marketing further comprises the step of establishing a management center to manage the network marketing campaign.

8. A method as in claim 1, wherein the step of identifying at least one product and/or service involves the more specific step of providing a product and/or service through an intermediary group.

9. A method as in claim 1, wherein the step of identifying at least one product and/or service typically acquired includes the more specific step of providing at least one product that is a utility provided by an intermediary group.

10. A method as in claim 8, wherein the step of identifying at least one product and/or service typically acquired includes the more specific step of providing at least one product that is a utility provided by an intermediary selected from the group consisting of telephone, electric, gas, sewer, water, and garbage.

11. A method as in claim 8, wherein the step of identifying at least one product and/or service typically acquired includes the more specific step of providing at least one product and/or service selected from the group consisting of insurance, mortgage securities, private loans, commercial loans, and investment placements.

12. A method as in claim 7, wherein the step of initiating a sale of at least one product and/or service comprises initiating the sale through the management center.

13. A method as in claim 12, further comprising the step of enabling the management center to establish an agreement with the non-profit organization for the non-profit organization to be an independent representative of an intermediary group.

14. A method as in claim 13, wherein a qualifying entity acts as an agent of the non-profit organization and the qualifying entity is an independent representative of the intermediary group.

15. A method as in claim 13, further comprising the step of enabling the intermediary group to pay profits earned from the sale of one and/or more goods and/or services provided by the intermediary group to the escrow account of the non-profit organization that earned said profits.

16. A system for funding a non-profit organization, comprising:
a means for identifying persons having an interest in a non-profit organization;
a means for identifying at least one product and/or service typically acquired by those persons;
a means for initiating a sale of the at least one product and/or service made to the persons having an interest in the non-profit organization; and
a means for organizing distribution of earnings from the sale of the at least one product and/or service to an escrow account; and
a means for organizing distribution of the earnings in the escrow account according to instructions provided by the non-profit organization.

17. A computer-implemented system for funding a non-profit organization, comprising:
a computer implemented means for identifying persons having an interest in a non-profit organization;
a means for identifying at least one product and/or service typically acquired by the persons having an interest in the non-profit organization;
a means for initiating a sale of the at least one product and/or service made to the persons having an interest in the non-profit organization;
a computer implemented means for organizing a distribution of earnings from the sale of the at least one product and/or service to an escrow account; and
a computer implemented means for organizing distribution of the earnings from the escrow account according to instructions from the non-profit organization.

18. A computer implemented system for funding a non-profit organization according to claim 17, further comprising a computer link to an Internet site for providing access to a list of persons having an interest in the non-profit organization.

19. A computer implemented system for funding a non-profit organization according to claim 17, further comprising a database coupled to the computer implemented means for accessing a list of persons having an interest in the non-profit organization.

20. A computer implemented system for funding a non-profit organization according to claim 17, further comprising software associated with the computer implemented means to organize the distribution of earnings from the sale of the at least one product and/or service.

21. A computer implemented system for funding a non-profit organization according to claim 20, further comprising a computer link to an internet site for providing access to the escrow account.

22. A computer implemented system for funding a non-profit organization according to claim 17, wherein the computer implemented means for organizing distribution of the earnings from the escrow account includes access to an Internet site.
